(19) United States
(12) Patent Application Publication
(10) Pub. No.: US 2006/0227196 A1
(43) Pub. Date: Oct. 12, 2006

(54) Electrophoretic display

(76) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/542,992

(22) PCT Filed: Jan. 13, 2004
(86) PCT No.: PCT/IB04/50013

§ 371 Date: May 2, 2006

(30) Foreign Application Priority Data
Jan. 24, 2003 (EP) 03100147.2

(51) Int. Cl. B41J 2/01

(52) U.S. Cl. 347/107

(57) ABSTRACT

The display device comprises a driver (10, 16) which supplies drive pulses to the pixels (18) to bring the pixels (18) in a predetermined optical state corresponding to image information to be displayed. A controller (15) controls the driver (10, 16) to successively supply a drive pulse (Vni) and a correction pulse (dni). The drive pulse (Vni) has a voltage level that is sufficiently high to bring the electrophoretic particles (8, 9) into a continuously moving state as long as the drive pulse (Vni) is present. Due to the history of the drive of the pixel (18) the desired optical state will usually be reached approximately only. The correction pulse (dni) has a voltage level which is too low for bringing the electrophoretic particles (8, 9) into a continuously moving state, as the drive pulse (Vni) does, but high enough for moving the electrophoretic particles (8, 9) over a relatively small distance with respect to dimensions of the pixels (18). Thus, the correction pulse (dni) causes a relatively small movement of the electrophoretic particles (8, 9) towards an equilibrium state.

The invention relates to an electrophoretic display, and to a display apparatus comprising such an electrophoretic display.

A display device of the type mentioned in the opening paragraph is known from the international patent application WO 99/53373. This patent application discloses an electronic ink display comprising two substrates, one of which is transparent, the other substrate is provided with electrodes arranged in row and columns. A display element or pixel is associated with an intersection of a row electrode and a column electrode. The display element is coupled to the column electrode via a thin film transistor (further referred to as TFT), the gate of which is coupled to the row electrode. This arrangement of display elements, TFI transistors and row and column electrodes together forms an active matrix. Furthermore, the display element comprises a pixel electrode. A row driver selects a row of display elements and the column driver supplies a data signal to the selected row of display elements via the column electrodes and the TFT transistors. The data signals correspond to graphic data to be displayed.

Furthermore, an electronic ink is provided between the pixel electrode and a common electrode provided on the transparent substrate. The electronic ink comprises multiple microcapsules of about 10 to 50 microns. Each microcapsule comprises positively charged white particles and negative charge black particles suspended in a fluid. When a negative voltage is applied to the common electrode, the white particles move to the side of the micro capsule directed to the transparent substrate and a viewer will see a white display element. Simultaneously, the black particles move to the pixel electrode at the opposite side of the microcapsule where they are hidden to the viewer. By applying a positive voltage to the common electrode, the black particles move to the common electrode at the side of the micro capsule directed to the transparent substrate and the display element appears dark to a viewer. When the voltage is removed, the display device remains in the acquired state and thus exhibits a bi-stable character. The electronic ink display with its black and white particles is particularly useful as an electronic book.

Grey scales can be created in the display device by controlling the amount of particles that move to the counter electrode at the top of the microcapsules. For example, the energy of the positive or negative electric field in the pixel caused by the voltage difference between the electrodes, defined as the product of field strength and time of application, controls the amount of particles moving to the top of the microcapsules.

The known display devices exhibit a so called dwell time. The dwell time is defined as the interval between two successive image updates. The switching behavior of an electrophoretic display depends strongly on the dwell time. Using a predetermined driving pulse, an increased dwell time often leads to an increased “under-drive”, i.e. a darker than desired state is obtained when switching from dark to bright, and a brighter than desired state is achieved when switching from bright to dark. The dwell time is in practice variable depending upon the usage model of the display and application. This limits the accuracy of the grey scales.

A disadvantage of the present display is that it exhibits an under-drive effect which leads to inaccurate grey scale reproduction. This under-drive effect occurs, for example, when an initial state of the display device is black and the display is periodically switched between the white and black state. For example, after a dwell time of several seconds, the display device is switched to white by applying a negative field for an interval of 200 ms. In a next subsequent interval no electric field is applied for 200 ms and the display remains white and in a next subsequent interval a positive field is applied for 200 ms and the display is switched to black. The brightness of the display as a response of the first pulse of the series is below the desired maximum brightness.

It is an object of the invention to provide a display device of the type mentioned in the opening paragraph which has an improved reproduction of grey scales.

To achieve this object, a first aspect of the invention provides a display device as defined in Claim 1. A second aspect of the invention provides a display apparatus as claimed in claim 11. Advantageous embodiments of the invention are defined in the dependent claims.

In the display device as defined in accordance with the first aspect of the invention, a driver supplies drive pulse waveforms to the pixels to bring the pixels in a predetermined optical state corresponding to image information to be displayed. A controller controls the driver to successively supply a drive pulse and a correction pulse. The drive pulse has a voltage level that is sufficiently high to bring the electrophoretic particles into a continuously moving state as long as the drive pulse is present. Due to the history of the drive of the pixel the desired optical state will usually be reached approximately only. The correction pulse has a voltage level which is too low for bringing the electrophoretic particles into a continuously moving state, as the drive pulse does, but high enough for moving the electrophoretic particles over a relatively small distance with respect to dimensions of the pixels. Thus, the correction pulse causes a relatively small movement of the electrophoretic particles towards an equilibrium state. At the correct level of the correction pulse, the desired optical state will be reached, substantially without influence of the drive history of the pixel.

In general, grey scales in electrophoretic displays are difficult to generate with high reproducibility. In general, they are created by applying voltage pulses for specified time periods. They are strongly influenced by image history, dwell time, temperature, humidity, lateral inhomogeneity of the electrophoretic foils etc.

In an electronic ink (further refereed to as E-ink) electrophoretic display device, the reflectivity is a function of particle distribution close to the front of the capsule whilst the particles are distributed across the entire capsule. Many particle distributions will give the same reflectivity. Thus, the reflectivity is not a one to one function of particle distribution. Only the voltage and time response of the particle movement is truly deterministic. The complete image history has to be considered to correctly address an E-Ink electrophoretic display, especially if the optical state has to change from an arbitrary grey state to another arbitrary grey state. The transition matrix-based driving scheme takes care of the image history. In this approach, up to 6 prior states may have to be considered and a minimum of 4 frame memories to obtain a reasonable accuracy for direct grey-to-grey state changes (the “full transition drive scheme”). The grey scale accuracy can be improved by increasing the number of prior states in the memory. In fact, each additional state added to the transition matrix increases the amount of image storage required linearly and the size of the transition matrix exponentially. A larger transition matrix also places more demands on the display controller, increasing power consumption, expenses and decreasing speed. The number of prior states necessary have to be minimised for acceptable display performance.

Thus, due to the image history or drive history of the electronic ink, conventional E-ink display devices require storage of several previous frames of data, a large look-up table, and massive signal processing circuits for the generation of data pulses of a new frame taking into account the drive history of the pixels. The prior art data pulses are the drive pulses of the present invention.

In the electrophoretic display device in accordance with the invention a single grey-to-grey transition experiment demonstrated that “robust” grey scales can be obtained by applying low DC-voltages. The switching speed is significantly improved by applying a drive pulse before the low dc voltage is applied.

In an embodiment of the invention as defined in claim 5, the voltage level of the correction pulse required for each one of the desired optical states is stored in a memory. It appeared that the drive pulse will bring the optical state of the pixel near to the desired optical state. A fixed level of the correction pulse will then cause the desired optical state to be reached. The desired optical state may be any state in-between and including the two extreme states. If black and white particles are used, the two extreme optical states are a black pixel and a white pixel, and the desired optical states comprise gray scales in-between and including these extreme optical states. The particles may be colored and the desired optical states include color shades possible with the colored particles.

In an embodiment of the invention as defined in claim 6, the optical sensitive element detects the optical state of the pixel, for example by measuring the amount of light reflected by the pixel. For every desired optical state the desired light output is known. For a particular desired optical state, the level of the correction pulse depends on the difference of the actual measured amount of light and the desired amount of light. It is possible to include a learning mechanism which stores the last determined level of the correction pulse required and the difference measured in the amount of light produced for each optical state. At the instant the level is found at which the difference is substantially zero, this level is used, and the measurement needs to be performed sporadically only to cope with aging effects.

In an embodiment of the invention as defined in claim 7, the voltage level, or the duration, or both the voltage level and the duration of the drive pulse is or are determined based on the transition drive scheme used in conventional E-ink display devices. Due to the fact that the optical state of a pixel of such a display depends heavily on the drive history of the pixel, it is only possible to obtain a correct reproduction of the desired optical states when the previous sequence of drive voltages supplied to the pixel is known. This requires storage of several previous frames of pixel drive voltages, a large look-up table and massive signal processing circuits for the generation of data pulses of a new frame.

However in combination with the present invention much improved reproduction of the desired optical states is obtained, even without using the full transition drive scheme. Consequently, the transition drive used together with the correction pulses in accordance with the invention will be significantly less complex as in the prior art as the drive history which has to be tracked need not extend over more than one or a few previous frames.

In an embodiment as defined in claim 8, the drive pulse comprises several levels. The use of the several levels enables to reach the desired light output more close as it is possible to more accurately control the movement of the particles at a lower value of the drive voltage. It is also possible to vary the time of occurrence of the several levels.

In an embodiment as defined in claim 9, a preset signal is supplied preceding the drive signal to the pixel. The preset signal comprises a pulse with energy sufficient to release the electrophoretic particle from a static state at one of the two electrodes, but too low too reach the other one of the electrodes. In this manner the under-drive effect is reduced. Because of the reduced under-drive effect, the optical response to an identical data signal (or drive signal, or drive voltage) supplied at different instants will be substantially equal, regardless of the history of the display device and in particular its dwell time. Without applying the preset pulses, after the display device is switched to a predetermined state e.g. a black state, the electrophoretic particles reach a static state. When a subsequent switching occurs to the white state, a starting momentum of the particles is low because their starting speed is close to zero, which results in a long switching time. The application of the preset pulses increases the starting momentum of the electrophoretic particles and thus shortens the switching time. Such a preset pulse can have a duration of one order of magnitude less than the time interval between two subsequent image updates. An image update is the period in time wherein the image information of the display device is renewed or refreshed. A further advantage is that the application of the preset pulses significantly reduces a prior history of the electronic ink.

In combination with the correction pulse in accordance with the invention, the influence of the history of the pixels reduces further and thus decreasing the requirements on storing and processing prior drive voltages of the pixels to calculate the present drive voltages of the pixels.

In an embodiment in accordance with the invention as defined in claim 10, the voltage magnitude of the correction pulse is selected between one half and three Volts. These voltage levels provide the envisaged limited movement of the particles in the pixels in a practical implementation of an electrophoretic display with the following characteristics: in an electrophoretic display where particles are able to continuously move across the capsule when applying voltages with magnitude of 15V in less than one second, we observe that particles do not move at voltages below 0.5V, whilst they show continuous movement at voltages in excess of 3V.

These and other aspects of the invention are apparent from and will be elucidated with reference to the embodiments described hereinafter.

In the Drawings:

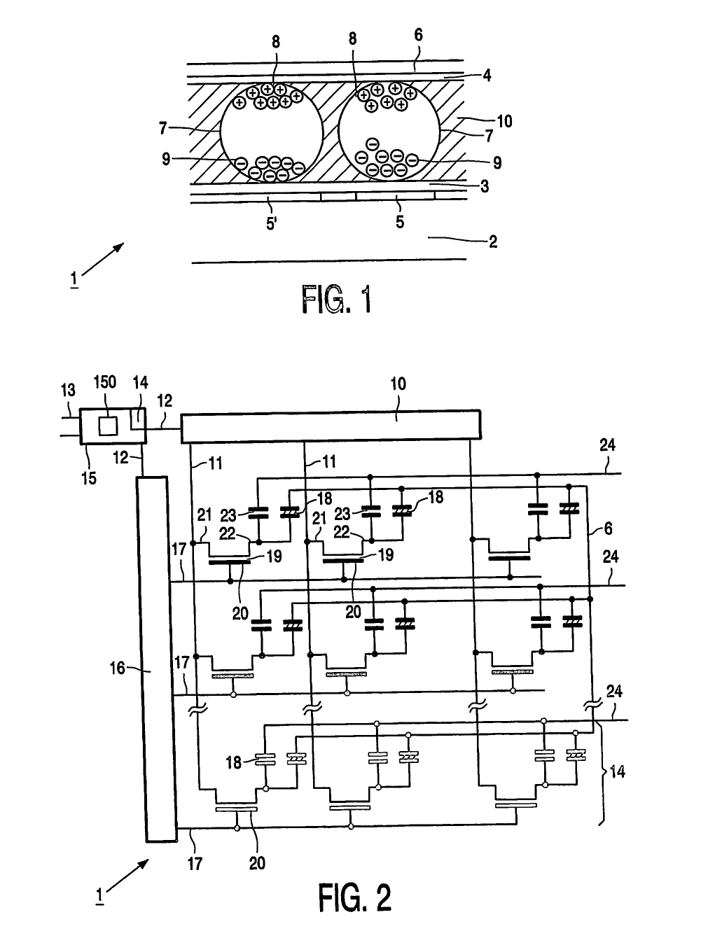

FIG. 1 shows diagrammatically a cross-section of a portion of an electrophoretic display device,

FIG. 2 shows diagrammatically an equivalent circuit diagram of a portion of the electrophoretic display device,

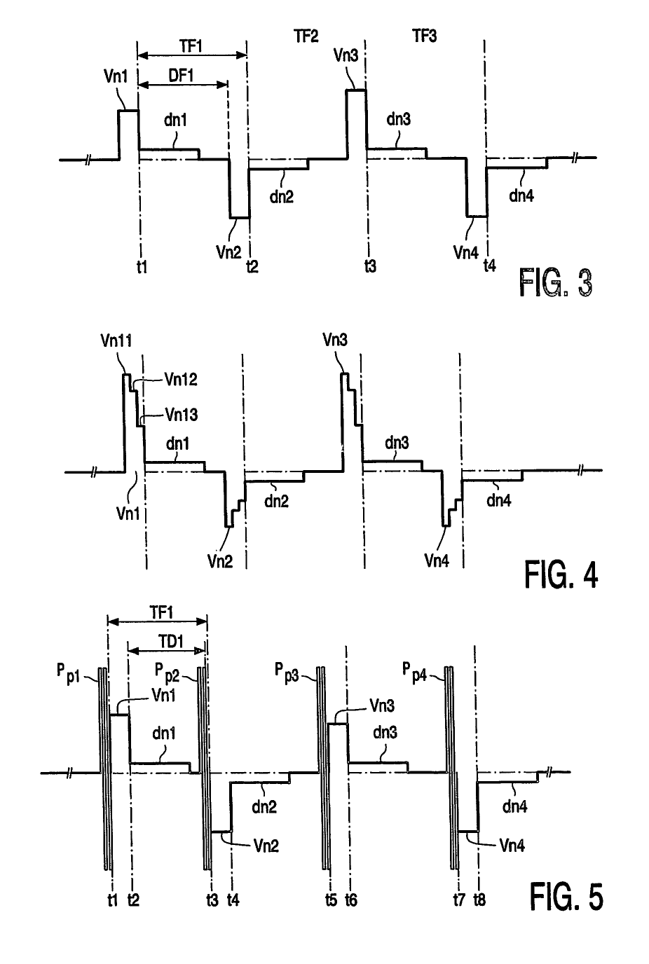

FIG. 3 shows drive signals which comprise a single level drive pulse and a correction pulse,

FIG. 4 shows drive signals which comprise a multilevel drive pulse and a correction pulse,

FIG. 5 shows the drive signals of FIG. 3 in which pre-pulses precede the single level drive pulse,

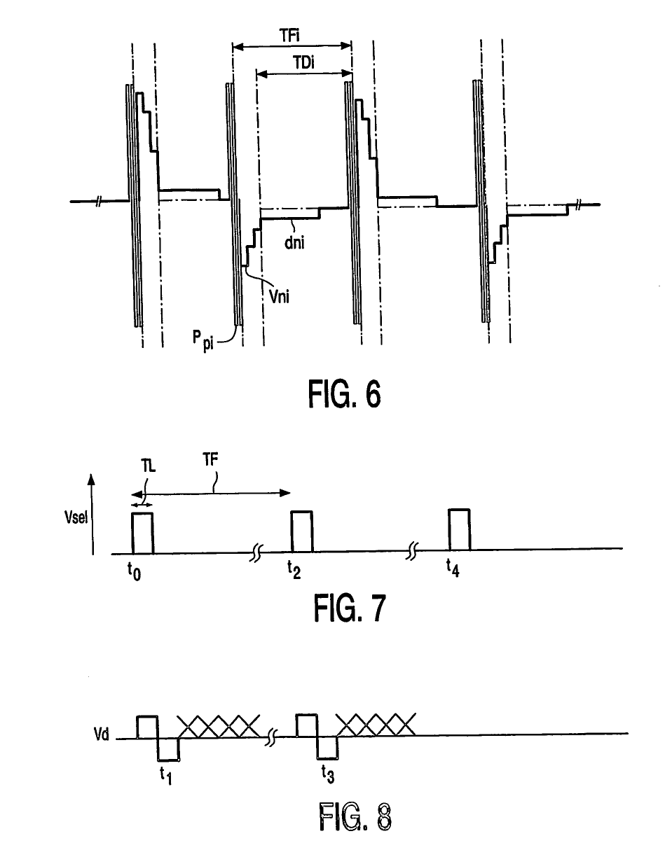

FIG. 6 shows the drive signals of FIG. 4 in which pre-pulses precede the multilevel drive pulse,

FIGS. 7 and 8 show drive signals of a conventional display device,

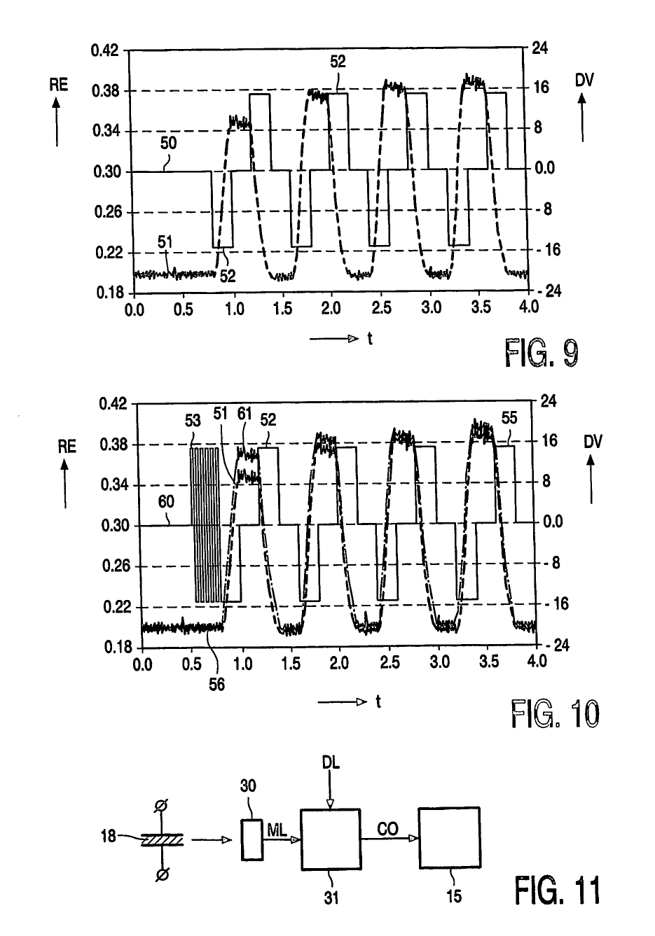

FIG. 9 shows an optical response of a display element on a data signal which comprises pulses of alternating polarity after a dwell period of several seconds,

FIG. 10 shows the optical response of a display device as a response of a series of twelve preset pulses of 20 ms and data pulses of 200 ms having a voltage of alternating polarity of plus and minus 15 V, and

FIG. 11 shows a circuit for measuring the amount of light leaving a display pixel.

The same references in different FIGS. refer to the same signals or to the same elements performing the same function.

FIG. 1 diagrammatically shows a cross-section of a portion of an electrophoretic display device 1, for example of the size of a few display elements, comprising a base substrate 2, an electrophoretic film with an electronic ink which is present between two transparent substrates 3 and 4 which, for example, are of polyethylene. One of the substrates 3 is provided with transparent picture electrodes 5, 5′ and the other substrate 4 with a transparent counter electrode 6. The electronic ink comprises multiple micro capsules 7, of about 10 to 50 microns. Each micro capsule 7 comprises positively charged white particles 8 and negative charged black particles 9 suspended in a fluid 40. The dashed material 41 is a polymeric binder. The layer 3 is not necessary, or could be a glue layer. When a negative voltage is applied to the counter electrode 6 with respect to the picture electrodes 5, an electric field is generated which moves the white particles 8 to the side of the micro capsule 7 directed to the counter electrode 6 and the display element will appear white to a viewer. Simultaneously, the black particles 9 move to the opposite side of the microcapsule 7 where they are hidden to the viewer. By applying a positive field between the counter electrodes 6 and the picture electrodes 5, the black particles 9 move to the side of the micro capsule 7 directed to the counter electrode 6 and the display element will appear dark to a viewer (not shown). When the electric field is removed the particles 7 remain in the. acquired state and the display exhibits a bi-stable character and consumes substantially no power.

FIG. 2 shows diagrammaticaly an equivalent circuit of a picture display device 1 comprising an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. The display device 1 is driven by active switching elements, which, for example, are thin film transistors 19. The display device 1 comprises a matrix of display elements at the area of intersecting row or selection electrodes 17 and column or data electrodes 11. The row driver 16 consecutively selects the row electrodes 17, while a column driver 10 provides data signals to the column electrodes 11 for the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16. Select signals from the row driver 16 which are electrically connected to the row electrodes 17 select the pixel electrodes 22 via the gate electrodes 20 of the thin film transistors 19. The source electrodes 21 of the thin film transistors 19 are electrically connected to the column electrodes 11. A data signal present at the column electrode 11 is transferred to the pixel electrode 22 of the display element 18 (also referred to as pixel) coupled to the drain electrode of the TFT. In the embodiment shown, the display device of FIG.1 further comprises an additional capacitor 23 at the location of each display element 18. This additional capacitor 23 is connected between the pixel electrodes 22 of the associated pixel 18 and one or more storage capacitor lines 24. Instead of a TFT other switching elements can be applied such as diodes, MIM's, etc.

The processor 15 may comprise a memory 150 for storing previous drive voltages of the pixels 18 required for the transition drive scheme, if applicable. Alternatively, the memory 150 may be used to store the levels of the correction pulses required for each optical state.

FIG. 3 shows drive signals which comprise a single level drive pulse and a correction pulse. The drive signals are shown for several frame periods TF1 to TF3, to which collectively is referred to as TFi. Each frame period has a dwell time DFi (only DF1 is explicitly shown) in which a correction pulse dni (dn1 to dn4) and a drive pulse Vni (Vn1 to Vn4) occurs.

In FIG. 3, the left-most drive pulse Vn1 will cause the pixel 18 to obtain an optical state near to a desired state at the instant t1 which is considered to be the start of a next dwell time DF1 during which the pixel 18 should have the desired optical state until the next drive pulse Vn2 is supplied. The frame time TF1 lasts from t1 to t2. The correction pulse dnl succeeding the drive pulse Vn1 and thus occurring during the dwell time DF1, causes the pixel 18 to substantially reach the desired optical state. The correction pulse dnl has a DC-level corresponding to the desired optical state (grey level). This DC-level of the correction pulse dn1 is retrieved as a predetermined value from a look-up-table. The DC-level may be empirically determined for each desired optical state. In a practical embodiment, typically, the duration of the drive pulses Vni is a few hundred milliseconds, whilst the duration of the correction pulses or DC-levels dni is a few seconds. The sign of the correction pulses dni is preferably the same as that of the drive pulses Vni. The level of the correction pulses dni is selected dependent on the optical state to be reached, and has a value such that the particles move a limited time only to reach a final state although the correction pulse is still supplied to the pixel. In a practical embodiment, the magnitude (positive or negative) of the correction pulses dni is between 0.5 and 3 volts.

The drive pulses Vni may be determined with a transition matrix drive scheme. Due to the corrective action of the correction pulses dni the grey scale can be set to the required level with a reduced amount of prior states compared to the prior art transition matrix driving scheme in which no correction pulses dni are used.

Experiments with a particular electrophoretic display sample, in which the optical response to a random sequence of the drive pulses Vni is recorded, revealed that when a DC-voltage (the DC-level of the correction pulse dni) of 2.25 V is supplied at the end of the random voltage sequence, a particular fixed grey level is reached. The particular brightness corresponding to this particular fixed grey level is reached after about 5 seconds of application of the DC-voltage.

It appeared that again, the same particular grey level is obtained by supplying the same DC voltage of 2.25 volts after a next random sequence of drive pulses Vni which is completely different from the preceding random sequence of drive pulses Vni.

Thus the correction pulses dni with a relatively low DC-voltage level enable to produce accurate grey scales, almost independent of the previous image history. This makes it possible to save the costs of the several frame memories and the large look-up-table required in the prior art transition matrix drive scheme. However, to further improve the reproducibility of the grey scales, the correction pulses dni can be combined with a simplified transition matrix drive scheme which is much simpler as in the prior art as a shorter history will suffice to reach the same performance.

Although it is shown that the desired optical states are approximately reached by varying the level of the drive pulses Vni, it is also possible to vary the duration of the drive pulses Vni at a fixed level, or to vary both the duration and the level.

FIG. 4 shows drive signals which comprise a multilevel drive pulse and a correction pulse. The correction pulses dni with the low DC-voltage levels may also be used in a driving scheme in which the drive pulses Vni have multiple levels. The multiple levels are explicitly indicated by Vn11, Vn12 and Vn13 for the drive pulse Vn1. These multiple levels Vn11, Vn12 and Vn13 may be determined with a transition matrix drive scheme. Although it is shown that the desired optical states are approximately reached by varying the level of the drive pulses Vni, it is also possible to vary the duration of the multiple levels Vn11, Vn12 and Vn13 of the drive pulses Vni at fixed levels, or to vary both the duration and the levels.

FIG. 5 shows the drive signals of FIG. 3 in which pre-pulses precede the single level drive pulse. The drive signals shown in FIG. 5 differ from the drive pulses shown in FIG. 3 in that a preset signal Ppi (shown are Pp1 to Pp4) precedes the drive pulse Vni.

The preset signals Ppi comprises a pulse with an energy sufficient to release the electrophoretic particles from a static state at one of the two electrodes, but too low too reach the other one of the electrodes. In this manner the under-drive effect is reduced. Because of the reduced under-drive effect, the optical response to an identical data signal (also referred to as drive signal, or drive voltage, and being identical to the drive pulse) Vni supplied at different instants will be substantially equal, regardless of the history of the display device and in particular its dwell time.

FIG. 6 shows the drive signals of FIG. 4 in which pre-pulses precede the multilevel drive pulse. The drive signals shown in FIG. 6 differ from the drive signals shown in FIG. 4 in that a preset signal Ppi precedes a drive pulse Vni.

FIGS. 7 and 8 show drive signals of a conventional display device. At the instance t0, a particular row electrode 17 is energized by means of a selection signal Vse1, while simultaneously data signals Vd are supplied to the column electrodes 11. After a line selection time TL has elapsed, a subsequent row electrode 17 is selected at the instant tl, etc. After some time, for example, a field time or frame time TF, usually 16.7 msec or 20 msec, said particular row electrode 17 is energized again at instant t2 by means of a selection signal Vse1, while simultaneously the data signals Vd are presented to the column electrode 11.

After a line selection time TL starting at to, t2 has elapsed, the next row electrode 17 is selected at the instant t1, t3. This whole process is repeated starting at instant t4.

Because of the bi-stable character of the display device, the electrophoretic particles remains in their selected state and the repetition of data signals Vd can be halted after several frame times TF when the desired grey level is obtained. Usually, the image update time is several frames TF, thus to reach the desired grey level, the same data signals Vd have to be applied during several successive frames TF.

FIG. 9 shows an optical response 51 of a display element of the display device of FIG. 2 on a data signal 50 which comprises pulses of alternating polarity after a dwell period Tdi of several seconds. The optical response 51 is indicated by the dashed pulses and the data signal 50 by the non-dashed pulses. Each pulse 52 of the data signal 50 has a duration of 200 ms and a voltage level of alternatingly plus and minus 15 V. The final value of the optical response 51 requires third or fourth negative pulses.

The left most vertical axis indicates the reflection Re as a voltage measured, the right most vertical axis indicates the driving voltage DV in volts, and the horizontal axis indicates the time t in seconds.

In order to improve the accuracy of the desired grey level in response to the data signal, the processor 15 generates a single preset pulse Ppi or a series of preset pulses Ppi before the data pulses which are the overdrive pulses Vni of a next refresh field, wherein the pulse time of the preset pulses Ppi is typically 5 to 10 times less than the interval between two succeeding image updates. In case the interval between two image updates is 200 ms. The duration of a preset pulse is typically 20 ms.

The series of pre-pulses Ppi is supplied to a single pixel 18 or to all the pixels 18 which should be refreshed. The number and duration of the pre-pulses Ppi are predetermined, and for example stored in a memory. The voltage level of the pre-pulses Ppi is preferably the maximum voltage which the driver 10, 16 can cope with. Immediately after the overdrive pulse Vni, the correction pulse dni having the low DC-voltage level is supplied. This DC-level which corresponds to the grey level that will be achieved is also predetermined and stored in a look-up-table. The pulse time of a typical overdriving pulse Vdi is a few hundreds of milliseconds, whilst the duration of applying the DC voltage is a few seconds.

FIG. 10 shows the optical response of a data signal 60 of the display device of FIG. 2 as a response of a series of twelve preset pulses 53 of alternating polarity and a duration of 20 ms, and data pulses 55 of 200 ms having a voltage of alternating polarity of plus and minus 15 V. The optical response 51 is indicated by dashed pulses (----), the improved optical response 61 by dashed-dot pulses (-.-.-.-.-), and the data signal by non-dashed pulses 55.

The left most vertical axis indicates the reflection Re as a voltage measured, the right most vertical axis indicates the driving voltage DV in volts, and the horizontal axis indicates the time t in seconds.

The voltage of each data pulse 55, which is the overdrive pulse Vni, is plus or minus 15 V. FIG. 10 shows an significant increase of the grey scale accuracy, the optical response 61 after the first data pulse 55 is substantially at a same level as the optical response after the fourth data pulse 55.

Thus, when these preset pulses Ppi or 53 precede the data pulses 55, which are the overdrive pulses Vni, and the correction pulses dni in accordance with an embodiment of the invention are implemented, the desired optical state of the pixels 18 will be reached substantially without any influence of the drive history of the pixels 18. Consequently, the transition matrix drive scheme is superfluous, or can be very simple.

However, some flicker may become visible introduced by the preset pulses 53 if the pre-pulse gets a bit longer, or starts at a middle grey level. In order to reduce the visibility of this flicker, the processor 15 and the row driver 16 can be arranged such that the row electrodes 17 associated with display elements are interconnected in two groups, and the processor 15 and the column driver 10 are arranged for executing an inversion scheme by generating a first preset signal Ppi having a first phase to the first group of display elements 18 and a second reset signal Ppi having a second phase to the second group of display elements 18, whereby the second phase is opposite to the first phase. Alternatively, multiple groups can be defined, whereto reset pulses 53 are supplied with different phases. For example, the row electrodes 17 can be interconnected in two groups one of the even rows and one group of the odd row whereby the processor generates a first preset signal consisting of six preset pulses of alternating polarity of plus and minus 15 V starting with a negative pulse to the display elements of the even rows and a second preset signal consists of six preset pulses of alternating polarity of plus and minus 15 V starting with a positive pulse to display elements of the odd rows.

Instead of the series of preset pulses applied to two or more different groups of rows, the display elements 18 can be divided in two groups of columns, for example, one group of even columns and one group of odd columns whereby the processor 15 executes an inversion scheme by generating a first preset signal consisting of six preset pulses of alternating polarity of plus and minus 15 V starting with a negative pulse to the display elements of the even columns and a second preset signal consists of six preset pulses of alternating polarity of plus and minus 15 V starting with a positive pulse to the display elements of the odd columns. Here, all rows can be selected simultaneously. In further alternatives, inversion schemes as just discussed can be simultaneously supplied to both rows and columns to generate a so called dot-inversion scheme, which still further reduces optical flicker,

A driving scheme with both voltage modulation and pulse width modulation is particularly desirable when the number of voltage levels and/or the voltage range is limited in a driver (which usually is an integrated circuit). Such a driving scheme is often referred to as “pulse-shaping drive scheme”. The transition matrix table in a pulse-shaping driving scheme is complicated and it becomes unacceptable long when a large number of previous states need to be included The use of the low DC-voltages (the correction pulses dni) reduces the number of prior states, and thus simplifies the look-up-table which saves cost and access time.

FIG. 11 shows a circuit for measuring the amount of light leaving a display pixel. The light leaving the display pixel 18 is measured by an optical sensitive element 30. A comparator 31 compares the measured light output ML with a desired light output DL to obtain a comparison signal CO. The controller 15 receives the comparison signal CO and adapts the voltage level of the correction pulse dcin to obtain the desired light output

It should be noted that the above-mentioned embodiments illustrate rather than limit the invention, and that those skilled in the art will be able to design many alternative embodiments without departing from the scope of the appended claims.

For example, the correction pulses may be applied in all types of electrophoretic display such as two electrode and three electrode displays.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A display device comprising:
pixels (18) with electrophoretic particles (8, 9),
a driver (10, 16) for supplying drive pulses to the pixels (18) to bring the pixels (18) in a predetermined optical state corresponding to image information to be displayed, and
a controller (15) for controlling the driver (10, 16) to successively supply a drive pulse (Vni) and a correction pulse (dcni), the drive pulse (Vni) having a voltage level for bringing the electrophoretic particles (8, 9) into a continuously moving state as long as the drive pulse (Vni) is present to approximate a desired optical state, the correction pulse (dcni) having a voltage level being too low for bringing the electrophoretic particles (8, 9) into a continuously moving state but high enough for moving the electrophoretic particles (8, 9) over a relatively small distance with respect to dimensions of the pixels (18) to reach the desired optical state.

2. A display device as claimed in claim 1, wherein the drive pulse has a single variable voltage.

3. A display device as claimed in claim 1, wherein the drive pulse has a variable duration.

4. A display device as claimed in claim 1, wherein the drive pulse is dependent upon at least one previous image.

5. A display device as claimed in claim 1, wherein, the voltage levels of the correction pulses (dcin) for the corresponding desired optical states, are stored in a memory (14).

6. A display device as claimed in claim 1, further comprising an optical sensitive element (30) for measuring a light output of a pixel (18); a comparator (31) for comparing the measured light output (ML) with a desired light output (DL) to obtain a comparison signal (CO), the controller (15) being adapted for receiving the comparison signal (CO) to adapt the voltage level of the correction pulse (dcin) to obtain the desired light output.

7. A display device as claimed in claim 1, wherein the controller (15) further comprises a calculation unit (150) for determining a duration, or a voltage level, or both a duration and a voltage level of the drive pulse (Vni) with a transition based driving scheme.

8. A display device as claimed in claim 1, wherein the controller (15) and the driver (10, 16) are adapted for supplying the drive pulse (Vni) having several levels (Vn11, Vn12, Vn13).

9. A display device as claimed in claim 1, wherein the display device further comprises a controller (15) being adapted for supplying a preset signal (53, 71. 72; 97) preceding the drive pulse (Vni), the preset signal (53, 71. 72; 97) comprising a preset pulse having an energy sufficient to release the electrophoretic particles (8, 9) at a first position near one of the two electrodes (5, 6) corresponding to a first optical state, but too low to enable the particles (8, 9) to reach a second position near the other electrode (5, 6) corresponding to a second optical state.

10. A display device as claimed in claim 1, wherein the voltage magnitude of the correction pulse (dcin) is selected between 0.5 and 3 Volts.

11. A display apparatus comprising a display device as claimed in claim 1.
